(19) United States
(12) Patent Application Publication
(10) Pub. No.: US 2014/0030139 A1
(43) Pub. Date: Jan. 30, 2014

(54) Cu-P-Ag-Zn BRAZING ALLOY

(71) Applicant: ALCOMA METAL CO., LTD., Gwangju-si (KR)

(72) Inventor: Chu Hyon Cho, Seoul (KR)

(73) Assignee: ALCOMA METAL CO., LTD., Gwangju-si (KR)

(21) Appl. No.: 13/953,747

(22) Filed: Jul. 30, 2013

(30) Foreign Application Priority Data
Jul. 30, 2012 (KR) 10-2012-0083289

(51) Int. Cl. B23K 35/30

(52) U.S. Cl. CPC B23K 35/302; B23K 35/3006
USPC 420/482; 420/483; 420/587

(57) ABSTRACT

The present invention relates to a Cu—P—Ag—Zn brazing alloy, and more particularly, to a brazing alloy composed of copper (Cu), phosphorus (P), zinc (Zn), and silver (Ag), and including one or two or more elements of indium (In), gallium (Ga), boron (B), tin (Sn), silicon (Si), germanium (Ge), lithium (Li), nickel (Ni), and manganese (Mn). The present invention is composed of 1% by weight to 50% by weight of silver (Ag), 10% by weight to 35% by weight of zinc (Zn), 0.01% by weight to 4% by weight of phosphorus (P), and the remainder of copper (Cu).

### CROSS-REFERENCE TO RELATED APPLICATIONS

This application claims priority to and the benefit of Korean Patent Application No. 10-2012-0083289 filed in the Korean Intellectual Property Office on Jul. 30, 2012, the entire contents of which are incorporated herein by reference.

### TECHNICAL FIELD

The present invention relates to a Cu—P—Ag—Zn brazing alloy, and more particularly, to a brazing alloy composed of copper (Cu), phosphorus (P), zinc (Zn), and silver (Ag), and including one or two or more elements of indium (In), gallium (Ga), boron (B), tin (Sn), silicon (Si), germanium (Ge), lithium (Li), nickel (Ni), and manganese (Mn).

### BACKGROUND ART

A Cu—P—Ag—Zn brazing is a welding material which is used when performing working at a temperature lower than the working temperature of a brass welding, a phosphorus bronze welding, and a phosphorus copper welding material, is usually used particularly in welding between dissimilar metals (iron, stainless steel, titanium, brass, and copper), and is widely used due to a low working temperature (melting point).

In the brazing as described above, a joining (soldering) process is performed using a brazing alloy containing silver, and the soldering work has been used as an important means in various industrial fields such as a cooling and heating apparatus, a contact, and a super hard tool. For example, brazing is widely used for internal and external piping of a compressor in a typical cooling and heating apparatus, silver contact welding in an electric switch, cutting, super hard welding for a drill hammer, and the like.

Further, soldering is used for coupling iron pipe parts or brass parts to a copper pipe and is classified into brazing (hard soldering) and soldering (soft soldering) according to a working temperature. In particular, brazing, which is a method of bringing metals into contact to be held together without melting a base material at a working temperature from about 500° C. to about 900° C., is a joining method for forming a strong and tight welded bond between two metals.

Accordingly, brazing is used variously for coupling between the same or similar metals, and dissimilar metals, coupling a thick portion and a thin portion, or coupling metals having greatly different melting points.

In particular, when stainless steel, iron, titanium, and the like are welded, a welding defect may be reduced when welding is performed in a short time at a working temperature of 850° C. or lower.

Currently, silver (Ag) is inevitably used as an alloy component for solving the problem. In particular, in the case of a pipe welding field, a material containing from 18% by weight to 57% by weight of silver (Ag) is used as a welding material when a brass part, a stainless steel, a terminal for contact is welded, and the reason for adding silver (Ag) is to improve flow-ability, wet-ability, adhesiveness, reduction in welding time, and the like on the surface of a base material while lowering a melting point.

However, silver (Ag) is an expensive precious metal, and a cost thereof is expected to continue to increase in consideration of the future development progress of an electronic industry, and the like. Therefore, in the economical aspect, there is a need for using inexpensive silver (Ag) or minimizing the silver (Ag) content, and in the aspect of weldability, a brazing alloy capable of further improving a self-fluxing function of a brazing alloy and an affinity between metals is required.

The present inventors have searched for an effort and a method to minimize the silver (Ag) content, lower the melting point, and improve welding characteristics, thereby completing the present invention.

### SUMMARY OF THE INVENTION

The present invention has been made in an effort to provide a brazing alloy composed of copper (Cu), phosphorus (P), zinc (Zn), and silver (Ag) such that the brazing alloy shows the same as or better weldability than that of a brazing alloy including silver (Ag) in the related art while being economically efficient due to a small content of silver (Ag), and including one or two or more elements of indium (In), gallium (Ga), boron (B), tin (Sn), silicon (Si), germanium (Ge), lithium (Li), nickel (Ni), and manganese (Mn).

To solve the above technical problem, the present invention comprises 1% by weight to 50% by weight of silver (Ag), 10% by weight to 35% by weight of zinc (Zn), 0.01% by weight to 4% by weight of phosphorus (P), and the remainder of copper (Cu).

The Cu—P—Ag—Zn brazing alloy may further include one or two or more elements selected from the group consisting of 1.0% by weight to 2% by weight of indium (In), 1.0% by weight to 2% by weight of gallium (Ga), 0.01% by weight to 1.6% by weight of boron (B), 0.1% by weight to 2% by weight of tin (Sn), 0.1% by weight to 0.75% by weight of silicon (Si), 0.01% by weight to 0.5% by weight of germanium (Ge), 0.01% by weight to 0.5% by weight of lithium (Li), 0.1% by weight to 2% by weight of nickel (Ni), and 0.1% by weight to 2% by weight of manganese (Mn).

The Cu—P—Ag—Zn brazing alloy according to the present invention is composed of copper (Cu), phosphorus (P), zinc (Zn), and silver (Ag), includes one or two or more elements of indium (In), gallium (Ga), boron (B), tin (Sn), silicon (Si), germanium (Ge), lithium (Li), nickel (Ni), and manganese (Mn), and lowers the silver (Ag) content than in the related art, thereby reducing the preparation costs and further enhancing weldability and workability as compared to a Cu—P—Ag—Zn brazing alloy in the related art.

Also, there is an effect of being harmless to the body since conventionally used welding material (Bag-1, Bag-2) comprising AWS standard cadmium can be replaced.

### BRIEF DESCRIPTION OF THE DRAWINGS

FIG. 1 is a photograph illustrating a cross-section of a joining of a Cu—Fe dissimilar metal pipe using a generally used brazing alloy.

FIG. 2 is a photograph illustrating a cross-section of a joining of a Cu—Fe dissimilar metal pipe using a Cu—P—Ag—Zn brazing alloy according to the present invention.

FIG. 3 is a photograph illustrating a cross-section welded by using the brazing alloy of FIG. 1, in which FIG. 3A is a photograph illustrating a cross-section of Comparative Example 1, FIG. 3B is a photograph partially enlarging the structure of FIG. 3A, and FIG. 3C is a photograph partially enlarging the structure of FIG. 3B.

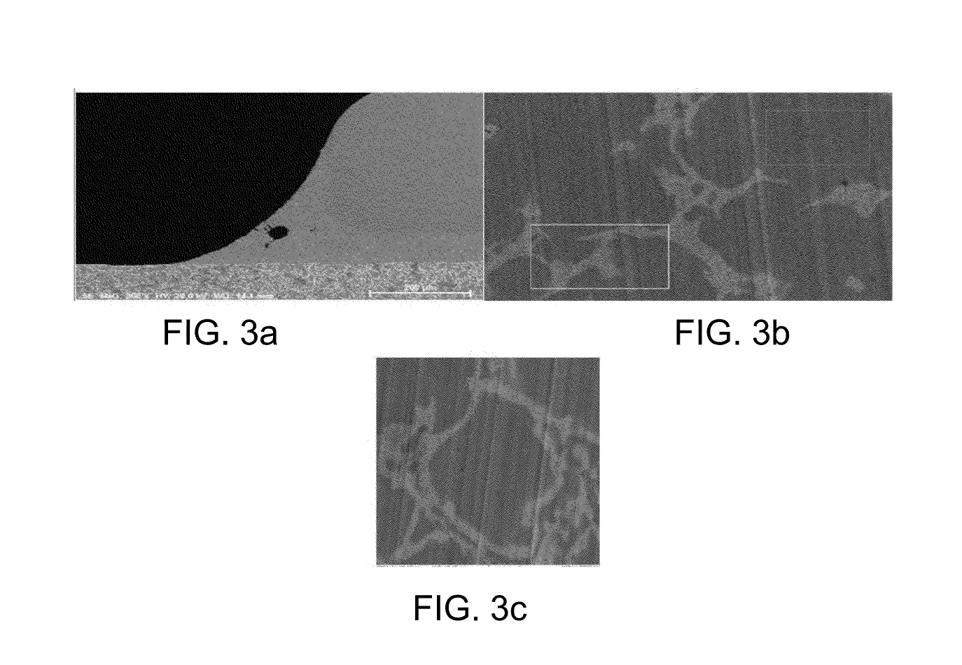

FIG. 4 is a photograph illustrating a cross-section welded by using the Cu—P—Ag—Zn brazing alloy of FIG. 2, in which FIG. 4A is a photograph illustrating a cross-section of Example 2, FIG. 4B is a photograph partially enlarging the structure of FIG. 4A, and FIG. 4C is a photograph partially enlarging the structure of FIG. 4B.

### DETAILED DESCRIPTION

Preferred exemplary embodiments of the present invention will be described with reference to the accompanying drawings for better understanding of the present invention. Exemplary embodiments of the present invention may be modified in various forms, and the scope of the present invention should not be construed as being limited to the exemplary embodiments described in detail below. The present exemplary embodiment is provided for more completely explaining the present invention to those skilled in the art. Therefore, the shapes of elements and the like in the drawings may be exaggeratedly expressed for emphasizing a clearer explanation. It should be noted that the same member in each drawing may be denoted by the same reference numeral in some cases. Furthermore, a detailed description of known functions and configurations determined to unnecessarily obscure the gist of the present invention will be omitted.

Hereinafter, a Cu—P—Ag—Zn brazing alloy of the present invention will be described in detail by explaining preferred exemplary embodiments of the present invention with reference to the accompanying drawings.

The Cu—P—Ag—Zn brazing alloy according to an exemplary embodiment of the present invention is an alloy in which one or two or more elements of indium (In), gallium (Ga), boron (B), tin (Sn), silicon (Si), germanium (Ge), lithium (Li), nickel (Ni), and manganese (Mn) are added to a four-element alloy composed of copper (Cu) as a pivotal element, silver (Ag), zinc (Zn), and phosphorus (P), and characteristics and roles of the elements will be described below.

Silver (Ag) is the most useful and important element among the brazing alloy elements, and lowers a melting point thereof and improves wet-ability, processability, and the like. Silver (Ag) itself has excellent corrosion resistance, electrical conductivity, thermal conductivity and the like and has a characteristic in that the strength thereof is improved when silver (Ag) is combined with another element. Further, since a silver (Ag) alloy has excellent penetration force in a molten state, a joining surface having excellent toughness may be obtained. Typically, a brazing alloy including from 18% by weight to 57% by weight of silver (Ag) is used.

However, the silver (Ag) content in the Cu—P—Ag—Zn brazing alloy according to the present invention is from 1% by weight to 50% by weight. This is because when the silver (Ag) content is less than 1% by weight, the effect of improving flow-ability, weldability, and the like is hardly exhibited and when 15% by weight of silver (Ag) is added, the same characteristics as those of a welding material containing 30% by weight of silver (Ag) are typically exhibited.

Zinc (Zn) is an element having a very low melting point and is an element added to lower the melting point of the alloy, and is an element improving flow-ability, wet-ability, and penetration force during welding.

The zinc (Zn) content in the Cu—P—Ag—Zn brazing alloy according to the present invention is preferably from 10% by weight to 35% by weight, when the content is 10% by weight or less, the melting point rises, and when the content exceeds 35% by weight, the extent of dezincification is increased during welding. Accordingly, the content is set to 35% by weight or less in the present invention.

Phosphorus (P) is a material having a very strong activity and serves to significantly reduce the liquidus of copper (Cu) up to 715° C. to 800° C. Further, phosphorus (P) performs a self-fluxing function by being easily coupled with an oxide of the surface of copper (Cu).

The phosphorus (P) content in the brazing alloy according to the present invention is from 0.01% by weight to 4% by weight. This is because when the phosphorus (P) content is less than 0.01% by weight, phosphorus only serves as a deoxidizer and when the phosphorus (P) content exceeds 4% by weight, the extent of dezincification is increased and brittleness is caused.

Indium (In) is a metal having a melting point of approximately 150° C., and an element which is widely used in a low-melting point alloy, and an element lowering the melting point of an alloy, improving flow-ability, and increasing inner toughness.

The indium (In) content in the Cu—P—Ag—Zn brazing alloy according to the present invention is from 1.0% by weight to 2% by weight.

Indium is an element which is melted at the lowest temperature, and it is preferred that indium is added in an amount of 1.0% by weight to 2% by weight.

Here, when the indium is added in an amount of 1% by weight or more, the surface tension thereof is rapidly decreased at a high temperature (from 650° C. to 850° C.), thereby suppressing weldability. Thus, it is preferred that indium is added in an amount of less than 2% by weight. In addition, when the content of indium is less than 1% by weight, an effect of improving the flow-ability is slight, and when the content of indium exceeds 2% by weight, brittleness of the alloy is caused.

Gallium (Ga) is an element for replacing silver in the Cu—P—Ag—Zn brazing alloy of the present invention, and an element priced lower than silver.

Furthermore, the gallium is an element for lowering the melting point, blocks the surface oxidation even at a high temperature, and increases the surface tension when melted.

Further, it is preferred that the gallium is added in an amount of 0.1% by weight in order to prevent the surface oxidation at a high temperature, and is added in an amount of 1% by weight to 2% by weight in order to lower the melting point.

Boron (B) is an element to increase penetration and diffusion force onto the surface of copper, iron, stainless steel, and titanium, is equivalent to phosphorus, and serve as a reducible self-flux, is confirmed as an element having a self-flux role better than that of phosphorus particularly in steel and a stainless steel material and substituting for brittleness of phosphorus, and is an alloy component added for preventing the occurrence of a void due to welding stress and a shrinkage cavity during solidification.

The boron (B) content in the brazing alloy according to the present invention is from 0.01% by weight to 1.6% by weight. This is because when the boron (B) content is less than 0.01% by weight, the flow-ability effect is slight and when the boron (B) content exceeds 1.6% by weight, the melting point is increased and brittleness occurs.

Since tin (Sri) has a very low melting point, kin (Sri) is an element added to lower the melting point of the brazing alloy. Furthermore, tin (Sn) improves flow-ability, wet-ability, penetration force, and the like of the molten brazing alloy.

The tin (Sn) content in the Cu—P—Ag—Zn brazing alloy according to the present invention is from 0.1% by weight to 2% by weight. This is because when the tin (Sn) content is less than 0.1% by weight, the effect of improving flow-ability, weldability, and the like is hardly exhibited and when the tin (Sn) content exceeds 2% by weight, low-temperature brittleness is caused.

Silicon (Si) is an important element added in a brass welding material and a Cu—P—Ag—Zn welding material, and an element which increases flow-ability of the welding material and suppresses dezincification.

It is preferred that the silicon (Si) content in the Cu—P—Ag—Zn brazing alloy according to the present invention is from 0.1% by weight to 75% by weight.

Germanium (Ge) is an element which refines a structure when a welded portion is solidified after welding and prevents corrosion on the welded surface.

It is preferred that the germanium (Ge) content in the Cu—P—Ag—Zn brazing alloy according to the present invention is from 0.01% by weight to 0.5% by weight.

Lithium (Li) is an element which is added in a small amount (from 0.01% to 0.5%) to lower the melting point when a low-temperature alloy is designed.

The lithium (Li) content in the Cu—P—Ag—Zn brazing alloy according to the present invention is from 0.01% by weight to 0.5% by weight.

When the lithium is added in an amount of 0.5% by weight or more, an oxidation film is rapidly formed at a high temperature such that the flow of a welding material is interrupted. Accordingly, it is preferred that the lithium is added in an amount of 0.5% by weight or less.

Nickel (Ni) is an element which is added in a typically used brazing alloy and improves mechanical characteristics. In particular, nickel (Ni) is used as an element which reduces dezincification.

It is preferred that the nickel (Ni) content in the Cu—P—Ag—Zn brazing alloy according to the present invention is from 0.1% by weight to 2% by weight.

Manganese (Mn) is an element which improves, when a steel material is welded, welding adhesion and mechanical properties on the surface thereof.

It is preferred that the manganese (Mn) content in the Cu—P—Ag—Zn brazing alloy according to the present invention is from 0.1% by weight to 2% by weight.

The brazing alloy according to the present invention includes copper (Cu) as a remainder except for the alloy components.

### Example 1

A Cu—P—Ag—Zn brazing alloy having the following composition was prepared.

TABLE 1

| | Cu | P | Ag | Zn | In | Ga | B | Si | Ge | Li | Mn | Cd |
|---|---|---|---|---|---|---|---|---|---|---|---|---|
| Example 1 | bal. | 1.4 | 12 | 26 | | | 0.01 | 0.1 | 0.1 | | 0.1 | |
| Example 2 | bal. | 3 | 20 | 25 | | 0.5 | 0.02 | 0.1 | | | | |
| Example 3 | bal. | 2 | 30 | 23 | 0.5 | 1.5 | 0.01 | 0.15 | 0.1 | | 0.1 | |
| Example 4 | bal. | 1 | 50 | 20 | 1 | 2 | 0.3 | 0.21 | 0.1 | | 1 | |
| Comparative | bal. | | 45 | 14 | | | | | | | | 25 |
| Example 1 | | | | | | | | | | | | |
| (AWS, Bag-1) | | | | | | | | | | | | |
| Comparative | bal. | | 30 | 30 | | | | | | | | |
| Example 2 | | | | | | | | | | | | |
| (AWS, Bag-20) | | | | | | | | | | | | |
| (% by weight) | | | | | | | | | | | | |

Each of the solidus and liquidus of the Cu—P—Ag—Zn brazing alloy prepared as above was measured, and the results thereof are shown in Table 2 and the drawings.

TABLE 2

| | Solidus (° C.) | Liquidus (° C.) |
|---|---|---|
| Example 1 | 723 | 767 |
| Example 2 | 712 | 762 |
| Example 3 | 665 | 731 |
| Example 4 | 605 | 635 |
| Comparative Example 1 | 607 | 618 |
| Comparative Example 2 | 677 | 716 |

### <Evaluation of Weldability: Joining of Dissimilar Metal Pipes of Copper Pipe and Iron Pipe>

Twenty Cu—Fe dissimilar metal joining samples were welded under the following welding conditions, followed by cutting and then the cross-sections thereof were examined.
Object to be joined: iron pipe having a diameter of 6.3 mm and copper pipe having a diameter of 6.8 mm
Heating condition: introducing an LNG, a gas torch, and a gas flux (methyl borate)
Flux: AWS type/FB3A
Welding temperature: from 830° C. to 860° C.

Supplying a welding bar: Example 2 (Ag 20%), bobbin having a wire diameter of 1.8 mm, and automatically supplying a predetermined amount
Welding machine: automatic welding machine manufactured by SK Brazing Co.

As described in Table 2, the brazing alloy of Example 2 had a higher solidus temperature than that of Comparative Example 1. Therefore, a melting time of the welding material in Example 2 was longer than that in Comparative Example 1. However, since the penetration speed into the Cu—Fe dissimilar metal pipe in Example 2 was faster than that in Comparative Example 1, a welding completion time of Example 2 was quicker than that of Comparative Example 1 by one second.

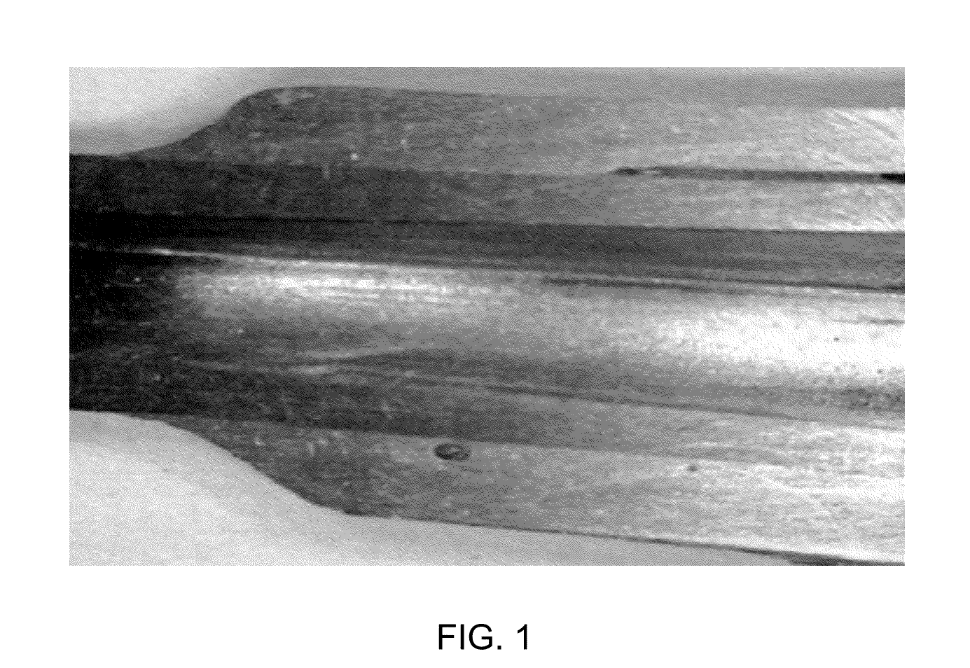

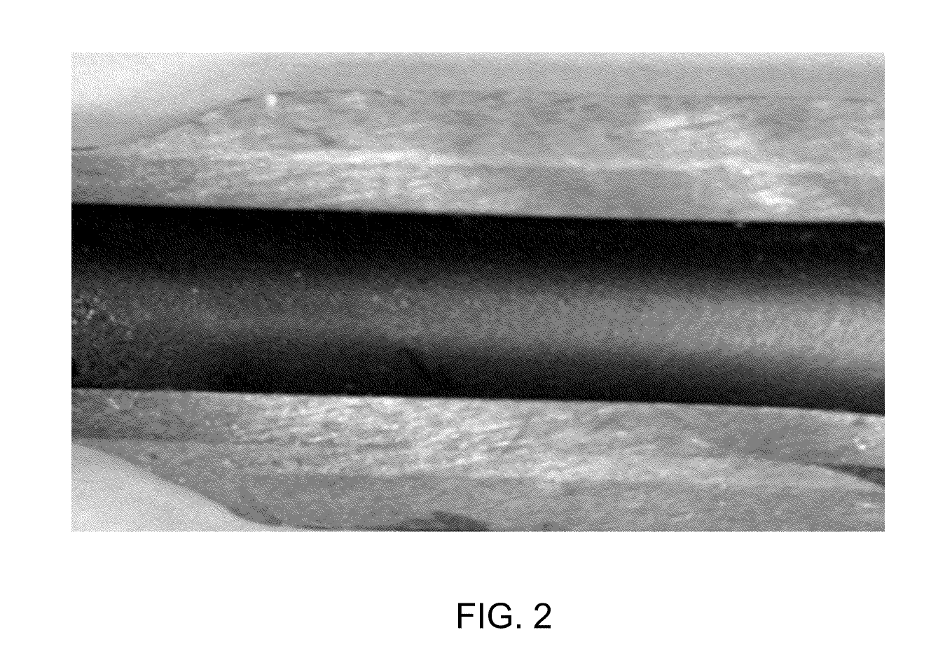

In addition, as illustrated in FIG. 1, it can be seen that when the brazing alloy of Comparative Example 1 was used, the inner side of the iron pipe was not clean and the distribution of the filler metal was poor even when visually confirmed. On the contrary, as illustrated in FIG. 2, it can be seen that when the brazing alloy of Example 2 was used, the inner side of the iron pipe was clean and the distribution of the filler metal was uniform.

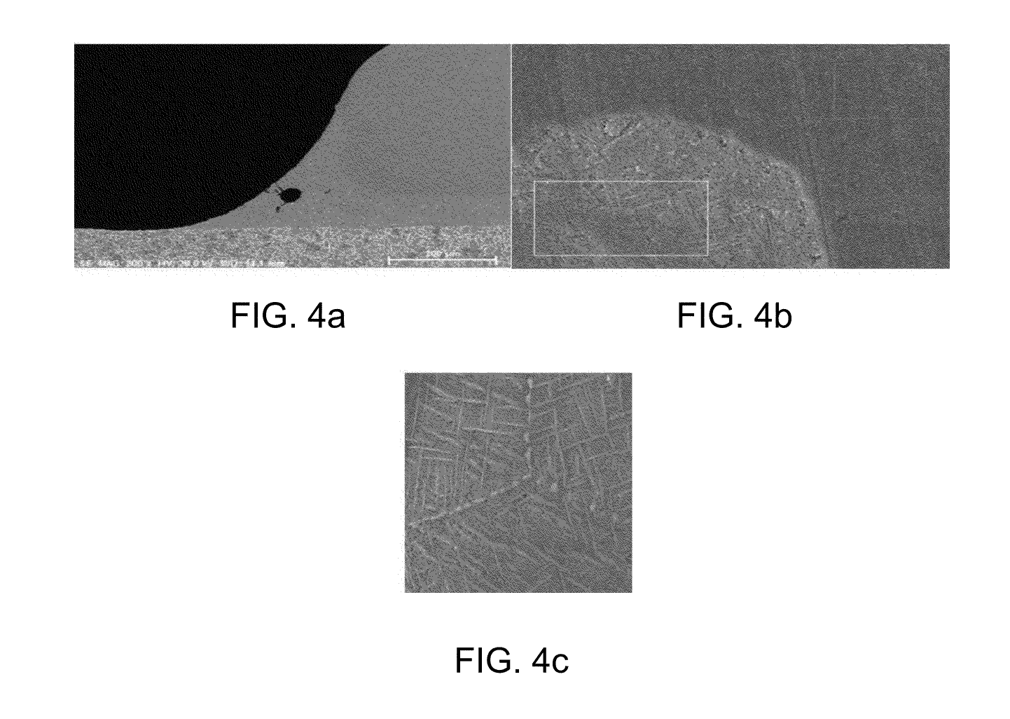

Moreover, as illustrated in FIGS. 2 and 4, when the brazing alloy of Comparative Example 1 was used, the grain size of the welded structure was large and the structure was not dense as illustrated in FIGS. 2A to 2C, such that the structure was susceptible to aging strain due to vibration or difference in temperature.

On the contrary, when the Cu—P—Ag—Zn brazing alloy of Example 2 was used, as illustrated in FIGS. 4A to 4C, the grain size of the welded structure was small and the structure was dense (pectination patterned structure) such that the structure was insusceptible to aging strain due to vibration or difference in temperature. Furthermore, since affinity between dissimilar metals is high, it is possible to reduce an unnecessary waste (flowing) of a filler metal during welding and obtain a bead better than in the related art.

Therefore, it can be seen that the Cu—P—Ag—Zn brazing alloy according to the present invention exhibits excellent weldability while containing a small amount of silver (Ag) compared to an alloy containing a large amount of silver (Ag) in the related art.

The Cu—P—Ag—Zn brazing alloy examples of the present invention as described above is only illustrative, and it will be understood by those skilled in the art that various modifications and other equivalent exemplary embodiments may be made. Therefore, it will be understood that the present invention is not limited only to the forms mentioned in the detailed description. Accordingly, the true technical scope of the present invention should be defined by the technical spirit of the appended claims. In addition, it is to be understood that the present invention includes all modifications, equivalents, and substitutions which fall within the spirit and scope of the present invention as defined by the appended claims.

What is claimed is:

1. A Cu—P—Ag—Zn brazing alloy comprising 1% by weight to 50% by weight of silver (Ag), 10% by weight to 35% by weight of zinc (Zn), 0.01% by weight to 4% by weight of phosphorus (P), and the remainder of copper (Cu).

2. The Cu—P—Ag—Zn brazing alloy of claim 1, further comprising:
one or two or more elements selected from the group consisting of 1.0% by weight to 2% by weight of indium (In), 1.0% by weight to 2% by weight of gallium (Ga), 0.01% by weight to 1.6% by weight of boron (B), 0.1% by weight to 2% by weight of tin(Sn), 0.1% by weight to 0.75% by weight of silicon (Si), 0.01% by weight to 0.5% by weight of germanium (Ge), 0.01% by weight to 0.5% by weight of lithium (Li), 0.1% by weight to 2% by weight of nickel (Ni) and 0.1% by weight to 2% by weight of manganese (Mn).
